(19) United States
(12) Patent Application Publication
(10) Pub. No.: US 2008/0148260 A1
(43) Pub. Date: Jun. 19, 2008

(54) Data Operating Device and Its Method

(75) Inventor: Kensuke Morita, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PZCKARD DEVELOPMENT COMPANY, L.P.

(21) Appl. No.: 10/585,346

(22) PCT Filed: Jan. 22, 2004
(86) PCT No.: PCT/JP04/00521

§ 371 Date: Jan. 23, 2008

(51) Int. Cl. G06F 9/46

(52) U.S. Cl. 718/101

(57) ABSTRACT

A database operating device and its method. A program for the operation can be easily developed and its debug maintenance is easily conducted. A transaction including at least one processing for operating a database is defined in an application layer. A memory area used only for the defined transaction is assigned. Using the memory area, a processing included in the transaction is executed. A processing for operating a database is defined as a component, i.e., a program module by a library. The operation of the database is executed in units of a defined transaction.

### TECHNICAL FIELD

The present invention relates to a connection control device and a connection control method for controlling connections to a database or the like.

### BACKGROUND ART

Databases are utilized in various fields of information processing in order to store data and share data among many users.

Structured Query Language (SQL), which has been developed by IBM Corporation, is commonly used to operate databases at present.

DBMS (Data Base Management System) is known as a system for storing and retrieving data by analyzing a program that is written in SQL.

Products to which SQL and DBMS are applied are disclosed in various documents including http://www.microsoft.com/sql/.

For example, COM+, which has been developed by Microsoft Corporation to support database operation, is disclosed in http://www.microsoft.com/japan/com/compres.asp.

Currently, a common way to operate a database is to performing database operation processing separately for a UI layer, which provides a user interface; an application layer, which provides functions for the business or other functions; and a data layer, which provides a function of accessing the database.

A database, which is implemented by allocating functions among three layers, as described above, is sometimes called a three-layer system.

In the three-layer database, programming of the application layer tends to be complicated and take many steps.

When applied to the three-layer database, COM+ mentioned above enhances the independence of the respective layers and facilitates programming of the layers.

On the other hand, the use of COM+ which enhances the independence of each layer tends to make debugging of a created program throughout all the layers difficult, and make maintenance after shipment of the product accordingly difficult.

[Non-Patent Document 1] http://www.microsoft.com/sql/

[Non-Patent Document 2] http://www.microsoft.com/japan/com/compres.asp

### DISCLOSURE OF THE INVENTION

The present invention has been made in view of the background described above, and it is an object of the present invention to provide a database operating device and a database operating method with which programming for operating a database is facilitated.

Another object of the present invention is to provide a database operating device and a database operating method with which debugging and maintenance of a program for operating a database are facilitated.

To attain the above-mentioned objects, according to the present invention, a database operating device for operating a database through processing divided into multiple layers, the processing being one or both of activating processing, which activates processing of another layer, and activated processing, which is activated by the activating processing, one or more of the activated processing being database operation processing for operating the database, includes: a group defining means which defines a processing group including one or more of the activating processing; and a processing control means which, in accordance with progress of activating processing included in the processing group and a processing result of database operation processing that is activated by the activating processing included in the processing group, controls at least what operation is performed on the database through the database operation processing.

Preferably, the layers are three or more separate layers, and the processing control means further controls, in accordance with the progress of the activating processing included in the processing group and the processing result of the activated processing that is activated by the activating processing included in the processing group but is not database operation processing, processing specifics (contents) of the activated processing that is not database operation processing.

Preferably, the database operating device further includes a library means which includes one or more of the database operation processing, in which activating processing that activates the database operation processing activates the database operation processing included in the library means.

Preferably, the database operating device further includes: a storage area setting means which sets, for each of the processing groups, a storage area for the activating processing that is included in the processing group and the activated processing that is activated by the activating processing included in the processing group; and a data management means which manages data used for processing included in each of the processing groups in the storage areas that are set to the respective processing groups.

Preferably, each one of the activated processing sends a returned value which shows the processing result to the activating processing that activates this activated processing, in which the layers include an interface layer, an application layer, and a database layer; the interface layer includes one or more of user interface processing which activates, as the activating processing, in response to external operation, the activated processing that is included in the application layer, and performs processing in accordance with the returned value sent from the activated processing that is activated by the user interface processing; the application layer includes one or more of application processing which, as the activating processing and the activated processing, is activated by the interface processing, activates one or more of the database operation processing included in the database layer, carries out a service that uses the database in accordance with the returned value sent from the activated database operation processing, and sends a result of the service as the returned value to the user interface processing; and the database layer includes one or more of the database operation processing which, as the database operation processing, is activated by the application processing, operates the database, and sends a result of the operation of the database as the returned value to the application processing.

Preferably, the processing control means controls execution of the database operation processing as follows: when the application processing included in the processing group activates the database operation processing for the first time, the activated database operation processing is connected to the database; and when the database operation processing that is activated last by the application processing included in the processing group, or when the database operation processing fails, the activated database operation processing is disconnected from the database.

Preferably, the processing control means commits to the database a result of the database operation processing activated by the application processing included in the processing group in a case where the database operation processing that is activated last by the application processing included in the processing group is successful, and, in any other cases, the processing control means restores the database to a state before the database operation processing is first activated by the application processing included in the processing group.

Preferably, when the database operation processing activated by the application processing included in the processing group fails, the processing control means restores the database to a state before the database operation processing is first activated by the application processing included in the processing group.

Further, according to the present invention, an information processing device for performing given information processing through processing divided into multiple layers, the processing being one or both of activating processing, which activates processing of another layer, and activated processing, which is activated by the activating processing, includes: a group defining means which defines a processing group including one or more of the activating processing; and a processing specifics control means which, in accordance with progress of the activating processing included in the processing group and a processing result of the activated processing that is activated by the activating processing included in the processing group, controls the specifics of the activated processing.

Further, according to the present invention, a database operating method of operating a database through processing divided into multiple layers, the processing being one or both of activating processing, which activates processing of another layer, and activated processing, which is activated by the activating processing, one or more of the activated processing being database operation processing for operating the database, includes: a defining step which defines a processing group including one or more of the activating processing; and a processing control step which, in accordance with progress of activating processing included in the processing group and a processing result of database operation processing that is activated by the activating processing included in the processing group, controls at least what operation is performed on the database through the database operation processing.

Further, according to the present invention, an information processing method for performing given information processing through processing divided into multiple layers, the processing being one or both of activating processing, which activates processing of another layer, and activated processing, which is activated by the activating processing, includes: a group defining step of defining a processing group which includes one or more of the activating processing; and a processing specifics control step of controlling, in accordance with progress of the activating processing included in the processing group and a processing result of the activated processing that is activated by the activating processing included in the processing group, specifics of the activated processing.

Further, a first program of the present invention relates to a program for a database operating device for operating a database through processing divided into multiple layers, the processing being one or both of activating processing, which activates processing of another layer, and activated processing, which is activated by the activating processing, one or more of the activated processing being database operation processing for operating the database, in which the program causes a computer to execute: a group defining step which defines a processing group including one or more of the activating processing; and a processing control step which, in accordance with progress of activating processing included in the processing group and a processing result of database operation processing that is activated by the activating processing included in the processing group, controls at least what operation is performed on the database through the database operation processing.

Further, a second program of the present invention relates to a program of an information processing device for performing given information processing through processing divided into multiple layers, the processing being one or both of activating processing, which activates processing of another layer, and activated processing, which is activated by the activating processing, in which the program causes a computer to execute: a group defining step of defining a processing group which includes one or more of the activating processing; and a processing specifics control step of controlling, in accordance with progress of the activating processing included in the processing group and a processing result of the activated processing that is activated by the activating processing included in the processing group, specifics of the activated processing.

According to the present invention, the database operating device and the database operating method with which programming for operating the database is facilitated are provided.

The present invention also provides the database operating device and the database operating method with which debugging and maintenance of the program for operating the database are facilitated.

### BRIEF DESCRIPTION OF THE DRAWINGS

FIG. 1 is a diagram showing in a list format a first example of a database operation program which is written in Structured Query Language (SQL).

FIG. 2 is a diagram showing in a list format a second example of a database operation program which is written in SQL.

FIG. 3 is a flow chart showing processing (S10) of the database operation program shown in FIG. 2.

FIG. 4 is a diagram conceptually showing the processing of the database operation program shown in FIG. 2.

FIG. 5 is a diagram showing in a list format a third example of a database operation program which is written in SQL.

FIG. 6 is a diagram illustrating difficulties in debugging the program shown in FIG. 5 as an example.

FIG. 7 is a diagram showing as an example a configuration of a network system to which a database operating method according to the present invention is applied.

FIG. 8 is a diagram showing, as an example, a hardware configuration of a server, a development/operation PC, and client PCs shown in FIG. 7.

FIG. 9 is a diagram showing a configuration of a server program which is executed in the server shown in FIG. 7.

FIG. 10 is a diagram showing a configuration of a development/control program which is executed in the development/operation PC shown in FIG. 7.

FIG. 11 is a diagram showing in a list format an example of a control program which is created by a program development assisting module shown in FIG. 10 and by others.

FIG. 12 is a flow chart showing processing (S12) of the control program shown in FIG. 11.

FIG. 13 is a diagram conceptually showing the processing and execution management of the control program shown in FIG. 11.

FIG. 14 is a flow chart showing control (S20) of execution of the processing of the control program (FIGS. 11-13) which is performed by a program execution control module of the development/control program shown in FIG. 10.

FIG. 15 is a diagram illustrating the ease of debugging of a control program with the development/control program (FIG. 10).

FIG. 16 is a program showing as an example a control program that includes multiple transactions in each layer.

### BEST MODE FOR CARRYING OUT THE INVENTION

[Background Leading to the Invention]

A further description is given on the background leading to the present invention in order to facilitate understanding of the present invention.

It is a general notion that database operation requires a user interface function through which a user operates a database and a processing result is displayed to the user, an application function for operating the database in accordance with the user's operation to provide various services to the user, and a database function for actually accessing the database (DBMS).

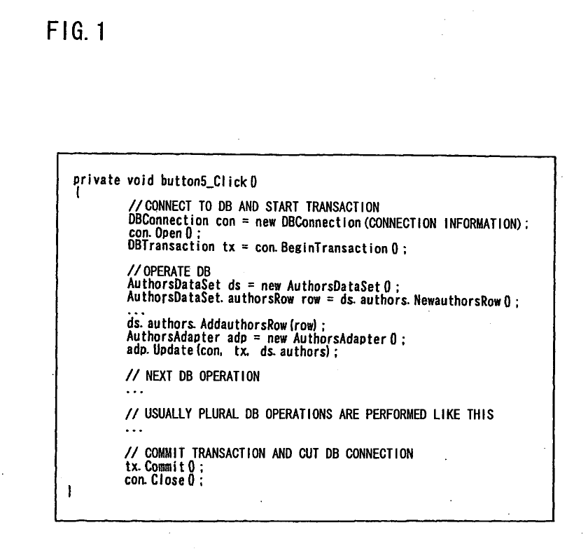

FIG. 1 is a diagram showing in a list format a first example of a database operation program which is written in Structured Query Language (SQL).

Those three functions could be attained without dividing a program into layers as shown in the form of a list in FIG. 1.

The program shown in FIG. 1 is written to operate a database as follows:

Each time a user enters a database operation command, first, a connection to the database (DB) is established and a transaction is started.

Next, as the transaction is started, necessary database operations are sequentially carried out.

After the database operation is finished, lastly, changes made to the database during the transaction and the like are committed, and the connection to the database is terminated.

However, writing a program without layering the program necessitates creating a program as the one shown in FIG. 1 for every combination of a user's operation command and a provided service.

Writing a program without layering the program therefore gives the program a large volume and provides an inflexible system configuration. In addition, since the program makes it difficult to divide a program module (mathematical function) into components, changing or adding a function is not easy.

For these reasons, a program for operating a database has now come to be created in a format that divides the program into a user interface layer (UI layer), which provides a user interface, an application layer (AP layer), which provides various services as applications of the database, and a database layer (DB layer), which actually operates the database.

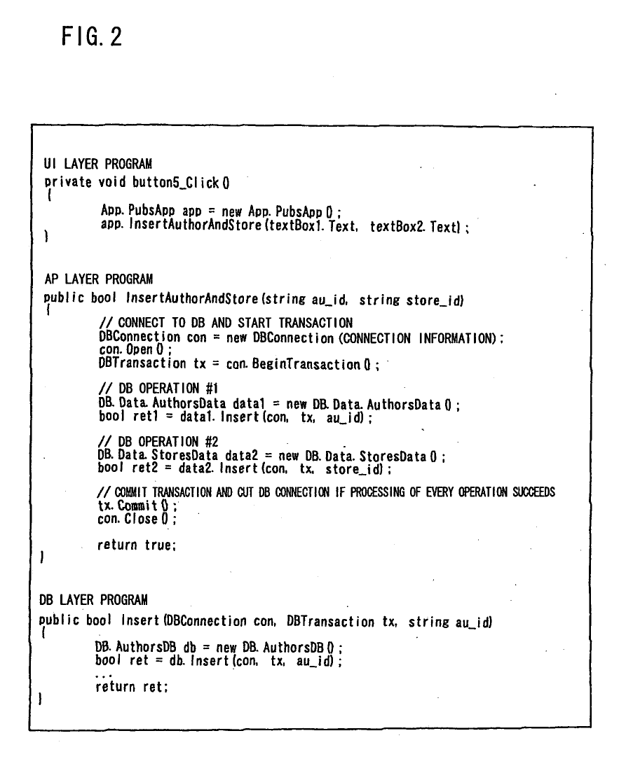

FIG. 2 is a diagram showing in a list format a second example of a database operation program which is written in SQL.

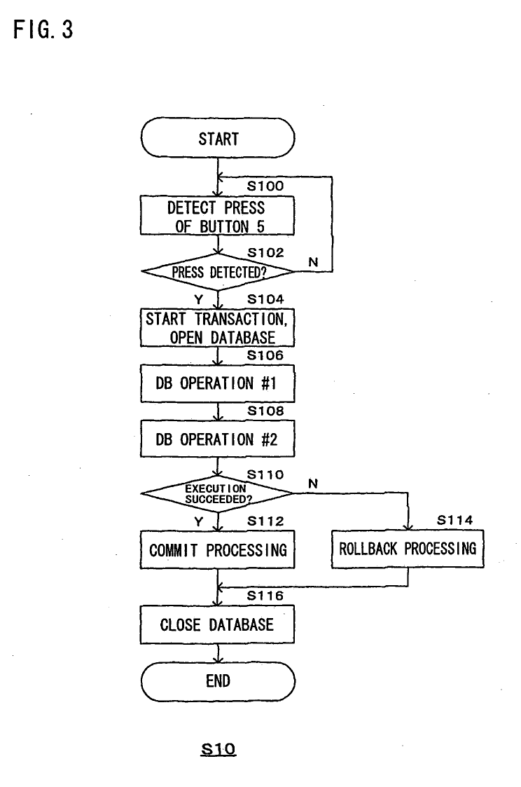

FIG. 3 is a flow chart showing processing (S10) of the database operation program that is shown in FIG. 2.

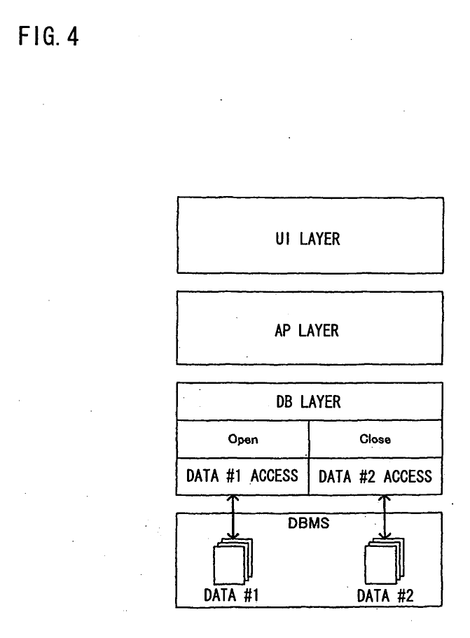

FIG. 4 is a diagram conceptually showing the processing of the database operation program that is shown in FIG. 2.

As shown in FIGS. 2-4, when a click on a “button 5” within a user interface image (not shown) displayed on a computer's screen or the like by a user is detected in processing of a user interface layer program, an application layer program is activated (S100 and S102 in FIG. 3).

In processing of the application layer, first, a connection to the database is made, the database is opened, and a transaction is started (S104 in FIG. 3).

Next, database operations (DB operations #1 and #2) are sequentially executed to provide a service. Each time database operation is executed, a database layer program is activated (S106 and S108 in FIG. 3).

In the case where every database operation succeeds, the processing of the application layer commits results of the database operations, closes the connection to the database, and sends the processing results and a returned value to the processing of the user interface layer (S110 and S112 in FIG. 3).

In any other cases, the processing of the application layer cancels the database operations and rolls back the transaction (S114 in FIG. 3).

Lastly, the processing of the application layer closes the connection to the database, and sends the processing results and a returned value to the processing of the user interface layer (S116 in FIG. 3).

The results of the processing of the application layer are presented to the user through the processing of the interface layer.

As shown in FIG. 2 as an example, programming database operation separately for the user interface layer, the application layer, and the database layer makes it easy to divide a program module into components. Therefore, compared to the case where database operation is programmed without dividing the program into layers as in the example of FIG. 1, a function can be changed or added more easily.

However, the example shown in FIG. 2 needs to create an object (con) for connecting with the database and an object (tx) for a transaction in the processing of the application layer in order to make database connection and transaction management common.

The created two objects are handed as arguments each time a program module that performs the processing of the database layer is called up.

In the database layer, the two objects have to be handed as arguments not only to a program module for processing of actually operating the database but also to a program module for other processing than operating the database. This is likely to complicate programming of the application layer (however, the program module for other processing than operating the database here is not included in the list shown in FIG. 2. When a subroutine is created in the application layer to call up the database layer, the two arguments have to be added to the subroutine to be handed over to the lower database layer despite the fact that the subroutine does not use con and tx. Such addition of arguments is labor-consuming when there are many subroutines).

A program module that performs the processing of the database layer could be created in a manner that would eliminate the need to hand over an argument. In this case, however, a function of a program module cannot be changed with the use of an argument, and many program modules that have slightly different functions have to be created in the database layer.

It therefore increases in number of programming steps in the database layer and consumes considerable labor in debugging and maintenance of the created programs.

The operating system Windows (registered trademark) of Microsoft Corporation has a function called COM+ in order to make a program module of the database layer into components.

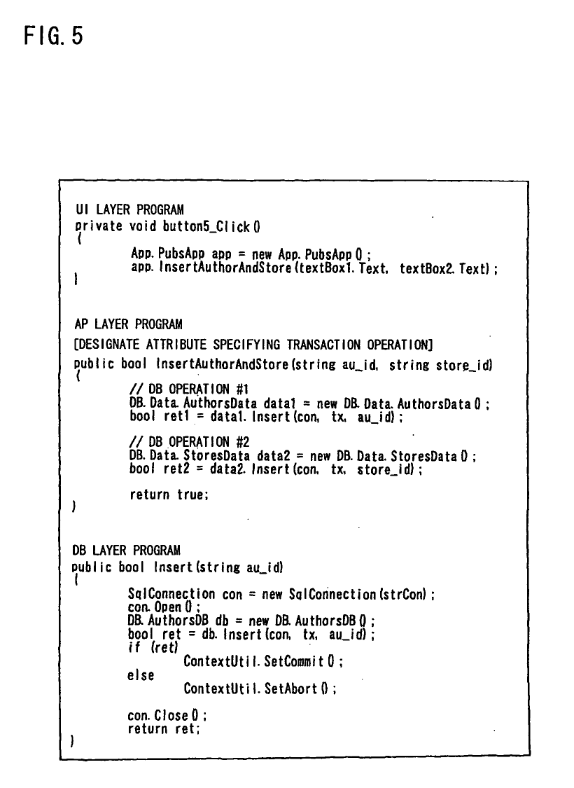

FIG. 5 is a diagram showing in a list format a third example of a database operation program which is written in SQL.

A program similar to the one shown in FIG. 2 but created with the use of COM+ is as shown in FIG. 5 as an example.

As shown in FIG. 5 as an example, when a click on the “button 5” is detected in the processing of the user interface layer program, the application layer program is activated.

In the processing of the application layer, first, an attribute specifying the operation of a transaction is designated, database operations (DB operations #1 and #2) are executed sequentially to provide a service, and the database layer program is activated each time database operation is executed.

Results of the activated processing of the database layer are sent as a returned value to the application layer. Processing results and returned value of the application layer are sent to the processing of the user interface layer.

The results of the processing of the application layer are presented to the user through the processing of the user interface layer.

The use of COM+ thus heightens the independence of program modules in the database layer from the application layer.

In addition, programming is simplified since the application layer does not need to hand over an argument to each program module of the database layer.

However, to program successfully with the use of COM+, a programmer has to learn a specification unique to COM+ until he/she is skilled in its use, which takes a lot of labor and time.

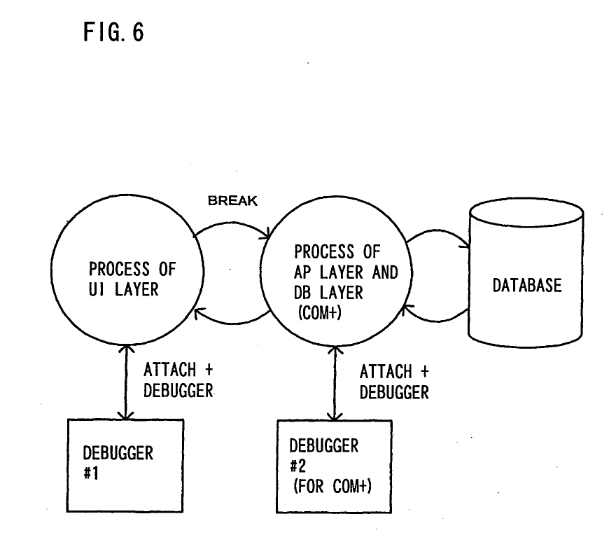

FIG. 6 is a diagram illustrating difficulties in debugging the program that is shown in FIG. 5 as an example.

Whereas the processing of the user interface layer shown in FIG. 5 as an example is executed following a common SQL processing method, the processing of the application layer and the database layer is executed following a processing method unique to COM+.

Even when a process carrying out the processing of the user interface (UI) layer in FIG. 6 is in operation and a debugger can be attached and can perform debugging, a process of the application layer and the database layer may not be in existence unless these layers are activated and, therefore, a debugger cannot always be attached.

Accordingly, in order to accomplish program operation check and debugging throughout the user interface layer, the application layer, and the database layer, it has to be done as follows, for example. A break point is set to processing of activating the application layer program in the process of the user interface layer and, after its execution is stopped, a debugger is separately attached to the process of the activated application layer and carries out debugging.

This can take even more labor and time in program debugging and maintenance than the case where COM+ is not employed.

The present invention has been made in view of the background described above, and an embodiment of the present invention solves all the drawbacks of the methods heretofore given as the background.

The following embodiment of the present invention is given as an example, and is not intended to limit the technical scope of the present invention.

Function allocation among components of the following embodiment of the present invention is not fixed; a function of one component may be divided among multiple components and functions of multiple components may be gathered to one component.

### EMBODIMENT

An embodiment of the present invention will be described below.

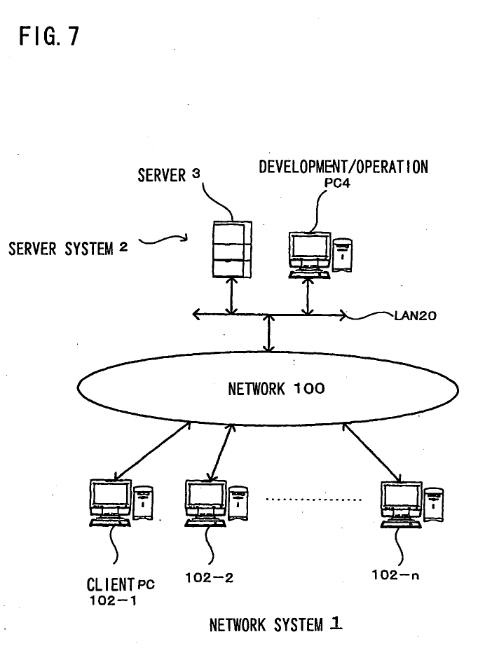

FIG. 7 is a diagram showing, as an example, a configuration of a network system 1 to which a database operating method according to the present invention is applied.

As shown in FIG. 7, the network system 1 employs a configuration in which a server system 2 is connected to client computers (client PCs) 102-1 to 102-n via a network 100 such as a LAN, a WAN, or the Internet.

The server system 2 has a configuration in which a server 3 and a development/operation PC 4 are connected to each other via a LAN 20.

In the network system 1, the server system 2 has, for example, a function as a Web server utilizing a database, and provides various services to the client PCs 102-1 to 102-n.

Hereinafter, the client PCs 102-1 to 102-n may be referred to simply as client PCs 102, and the same applies when there are multiple identical components.

Each component of the network system 1 may be referred to as node.

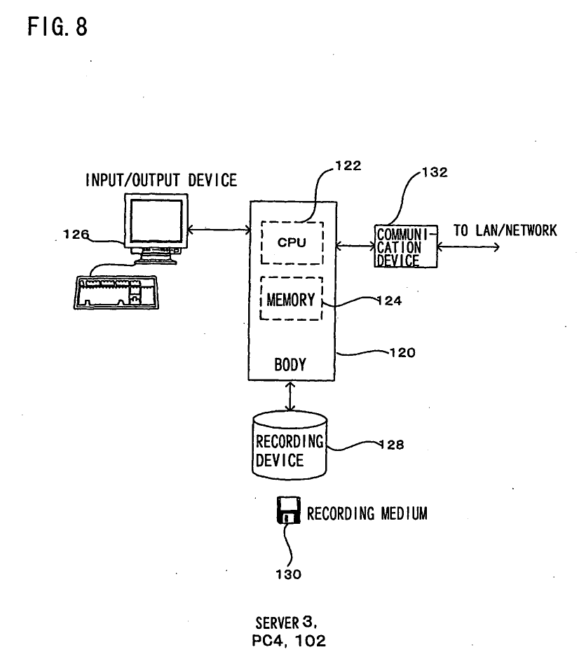

FIG. 8 is a diagram showing, as an example, a hardware configuration of the server 3, the development/operation PC 4, and the client PCs 102 which are shown in FIG. 7.

As shown in FIG. 8, the server 3, the development/operation PC 4, and the client PCs 102 are each composed of a computer body 120, which includes, among others, a CPU 122, a memory 124, and peripheral circuits of the CPU and the memory, an input/output device 126, which includes a display device, a keyboard, a mouse, and the like, a recording device 128, which records data in a recording medium 130 such as an FD, a CD, or an HD and plays the recorded data, a communication device 132, which communicates with another node via the network 100 (FIG. 7), and others.

In short, the server 3, the development/operation PC 4 and the client PCs 102 have components of a general computer that can communicate with another node through the network 100 or the LAN 20.

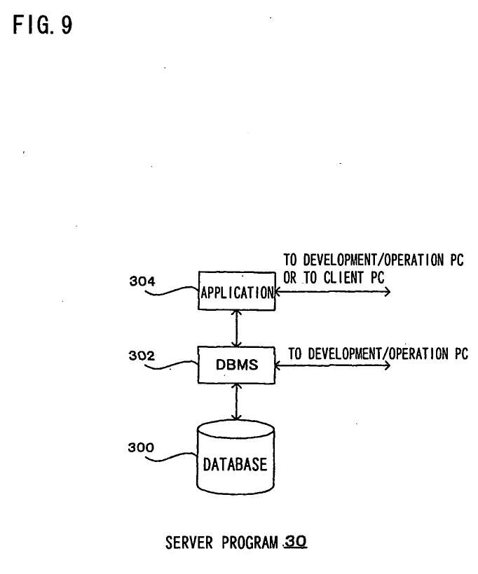

FIG. 9 is a diagram showing a configuration of a server program 30 which is executed in the server 3 shown in FIG. 7.

As shown in FIG. 9, the server program 30 is composed of a database module 300, a database management system module (DBMS) 302, and a service providing module 304.

The server program 30 is supplied to the server 3 through, for example, the recording medium 130, and loaded to the memory 124 (FIG. 8) to be executed (the same applies to programs described below).

The server program 30 uses those components to provide various services to the client PCs 102 (FIG. 7) under the control of the development/operation PC 4.

The DBMS 302 in the server program 30 operates the database module 300 under the control of the development/operation PC 4 to store data entered by the service providing module 304 in the database module 300.

The DBMS 302 also operates the database module 300 to read data stored in the database module 300 and outputs the read data to the service providing module 304.

The database module 300 stores data entered from the DBMS 302 and outputs stored data to the DBMS 302 in accordance with operation by the DBMS 302.

The database module 300 and the DBMS 302 perform the above-mentioned processing of the database layer, thereby providing database functions to the service providing module 304.

The service providing module 304 carries out services to the client PCs 102 and other components under the control of the development/operation PC 4, for example services as a database server or a Web server.

The service providing module 304 performs the above-mentioned processing of the user interface layer and of the application layer. In accordance with operation performed by users on operation images (not shown) which are displayed on the client PCs 102, the service providing module 304 utilizes the database functions provided by the database module 300 and the DBMS 302 to provide data stored in the database module 300 to the client PCs 102, or to store data entered by the client PCs 102 in the database module 300.

The service providing module 304 also makes the database module 300 store data entered by the development/operation PC 4 and output stored data to the development/operation PC 4 for debugging or other tasks in the development/operation PC 4.

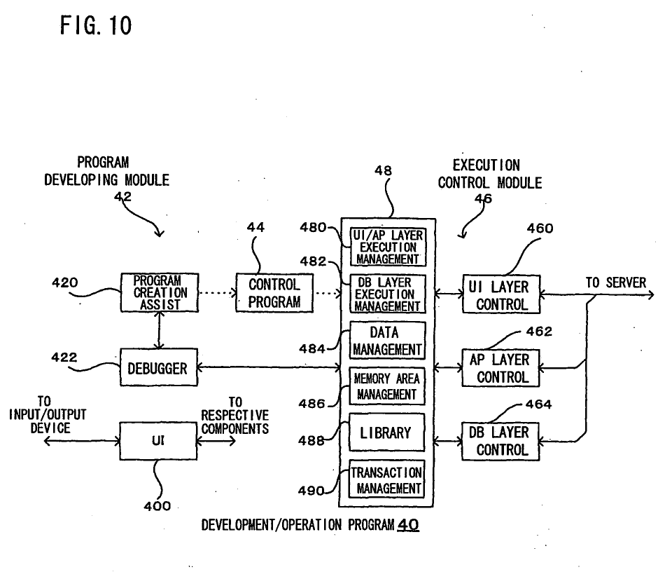

FIG. 10 is a diagram showing a configuration of a development/control program 40 which is executed in the development/operation PC 4 shown in FIG. 7.

As shown in FIG. 10, the development/control program 40 is composed of a UI module 400, a program developing module 42, and a program execution control module 46.

The program developing module 42 includes a program development assisting module 420, a debugger 422, and others.

The program execution control module 46 includes an execution control module 48, a UI layer control module 460, an AP layer control module 462, a DB layer control module 464, and others. The execution control module 48 is composed of a UI/AP layer execution management module 480, a DB layer execution management module 482, a data management module 484, a memory area management module 486, a library 488, and a transaction management module 490.

The development/control program 40 uses those components to develop and debug a control program 44, which controls the server program 30, in accordance with operation performed by a user.

The development/control program 40 controls execution of the control program 44 to carry out database operation in the server program 30 and desired database-using services.

The UI module 400 in the development/control program 40 provides a user interface function to a user of the development/operation PC 4.

The UI module 400 also controls processing of each component of the development/control program 40 in accordance with operation performed by a user.

The program development assisting module 420 in the program developing module 42 assists development of the SQL-format control program 44 by a user (programmer).

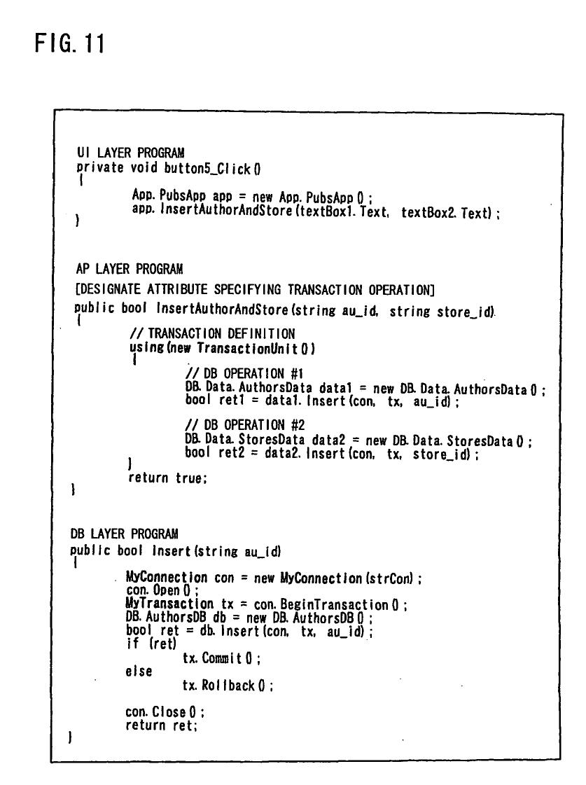

An example of the control program 44 developed by the program development assisting module 420 will be described later with reference to FIGS. 11-13.

The debugger 422 provides a debugging function for the control program 44, including step execution of the control program 44 which is developed with the use of the program development assisting module 420 and other components.

FIG. 11 is a diagram showing in a list format an example of the control program 44, which is created by the program development assisting module 420 shown in FIG. 10 and other components.

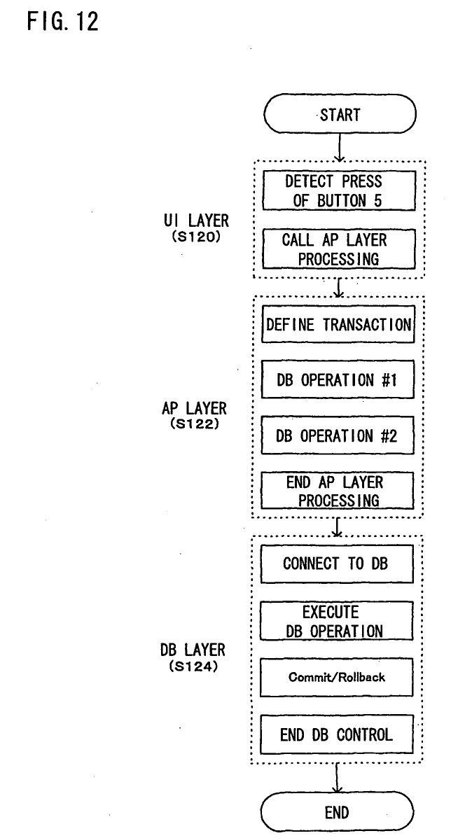

FIG. 12 is a flow chart showing processing (S12) of the control program 44 that is shown in FIG. 11.

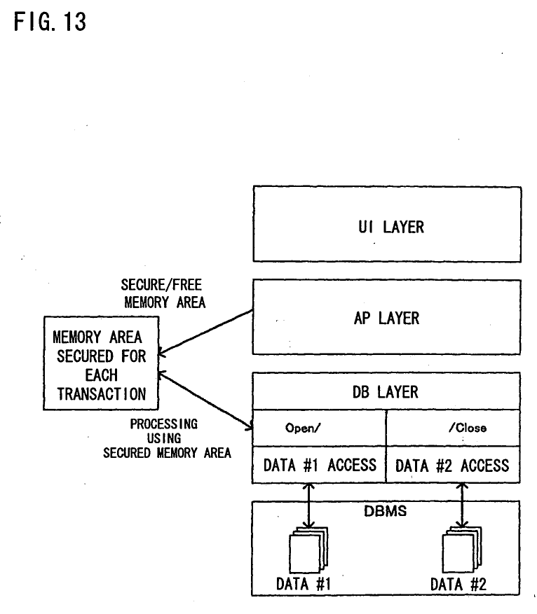

FIG. 13 is a diagram conceptually showing the processing and execution management of the control program 44 shown in FIG. 11.

The program development assisting module 420 creates the control program 44 as the one shown in FIGS. 11-13.

This control program 44 performs the same processing as the program shown as an example in FIGS. 1, 2 and 5 for easy comparison.

AS shown in FIGS. 11-13, an application layer program is activated (S120 in FIG. 12) when it is detected in processing (S120) of the user interface layer performed by the control program 44 that the “button 5” within a user interface image (not shown) displayed on the display device screen of the input/output device 126 of the client PC 102 (FIG. 8) is clicked on by a user.

In processing of the activated application layer (S122), first, the unit of transaction is specified.

The transaction includes activating one or more kinds of database layer processing necessary to provide a service by the server 3 in the processing of the application layer (S122).

The example shown in FIGS. 11-13 is a case of activating database layer processing for the DB operations #1 and #2.

Continuous memory areas dedicated to processing in the transaction are secured in the memory 124 (FIG. 8) of the development/operation PC 4 along with the definition of the transaction (FIG. 13).

Data used in all kinds of processing included in transactions is stored and managed in memory areas secured specially for the respective transactions.

The thus secured memory areas also store a connection object necessary to connect with the database.

The stored connection object is used for processing as the need arises, and the need to hand over an argument is therefore eliminated.

Next, data base layer processing is activated sequentially for operations performed on the server 3 (the DB operations #1 and #2).

When these operations are finished, the processing of the application layer is ended.

In the processing of the database layer (S124), a connection to the database (the DBMS 302 and the database module 300 in FIG. 9) is made.

Then the processing for database operation that is activated by the processing of the application layer is executed.

Program modules performing processing for database operation are provided as program modules made into components and included in the library.

FIG. 11 shows, as examples of database layer program modules thus made into components, &quot;MyConnection&quot;, which is for connecting to the database (the DBMS 302 and the database module 300 of FIG. 9) in a transaction defined in the application layer and &quot;MyTransaction&quot;, which is for operating the database in this transaction.

Results of the processing for database operation are committed to the database module 300, or the processing is cancelled and the transaction is rolled back.

As the processing for database operation is finished, the processing of the database layer is ended.

Execution of processing of the control program 44 shown in FIGS. 11-13 as an example is controlled by the program execution control module 46 (FIG. 10) as will be described later.

Reference is made again to FIG. 10.

In the execution control module 48, the UI/AP layer execution management module 480 interprets the user interface layer program and application layer program of the control program 44, and manages execution of processing of these programs in each transaction.

The DB layer execution management module 482 interprets the database layer program of the control program 44, and manages execution of the database layer program in each transaction.

The memory area management module 486 secures and manages memory areas (FIG. 13) used for processing of respective transactions in the memory 124 (FIG. 8) of the development/operation PC 4.

The memory area management module 486 also frees memory areas of a transaction that has finished processing.

The data management module 484 manages data stored in memory areas in processing of respective transactions.

The library 488 provides program modules that perform processing of the database layer and are made into components.

The transaction management module 490 manages a transaction defined in the application layer.

The UI layer control module 460 and the AP layer control module 462 controls processing of the service providing module 304 of the server program 30 (FIG. 9) under the management of the UI/AP layer execution management module 480.

The DB layer control module 464 controls processing of the DBMS 302 and of the database module 300 under the management of the DB layer execution management module 482.

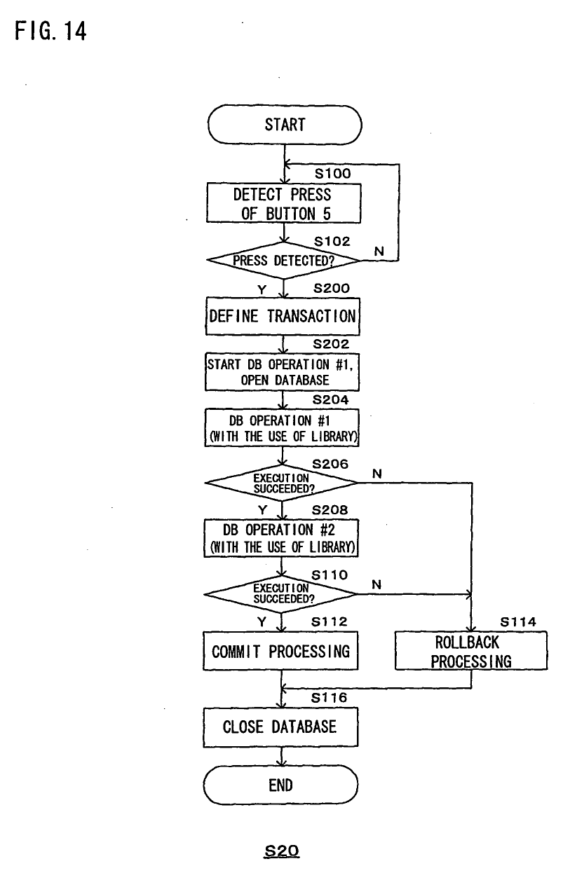

A further description will be given with reference to FIG. 14 on the processing of the program execution control module 46 of the development/control program 40.

FIG. 14 is a flow chart showing control (S20) of execution of the processing of the control program 44 (FIGS. 11-13) which is performed by the program execution control module 46 of the development/control program 40 shown in FIG. 10.

In FIG. 14, processing corresponding to the one shown in FIG. 3 is denoted by the same reference symbol.

As shown in FIG. 14, in Step 100 (S100), the service providing module 304 (FIG. 8) of the server program 30 detects that a user has pressed the button 5 in a user interface image displayed by the input/output device 126 of the client PC 102 (FIG. 7).

The service providing module 304 outputs the press detection result of the button 5 to the UI/AP layer execution management module 480 via the UI layer control module 460 of the execution control module 48 (FIG. 10).

The UI/AP layer execution management module 480 receives the press detection result of the button 5.

In Step 102 (S202), the UI/AP layer execution management module 480 (FIG. 10) interprets and executes the user interface layer program (FIGS. 11-13) of the control program 44 to judge whether or not a press of the button 5 is detected.

The program execution control module 46 proceeds to processing of S200 in the case where the press of the button 5 is detected, and returns to the processing of S200 in any other cases.

In Step 200 (S200), the UI/AP layer execution management module 480 (FIG. 10) interprets and executes the application layer program to specify attributes of a transaction and define the transaction.

A transaction is specified from a class declaration part of the application layer. FIG. 11 shows as an example a case of specifying a transaction with the use of the programming language C# of Microsoft Corporation.

This part is referred to when processing of connecting to the server 3 is performed, and its operation is changed accordingly.

The memory area management module 486 secures and manages memory areas used for processing of the defined transaction.

The data management module 484 manages data stored in the secured memory areas.

The transaction management module 490 manages the defined transaction.

In Step 202 (S202), the UI/AP layer execution management module 480 (FIG. 10) starts first processing (the DB operation #1) for operating the database (the DBMS 302 and the database module 300 of FIG. 9), and activates processing of the database layer program.

The database layer program for the first processing is provided by the library 488 as a program module that is made into components.

The activated database layer program is interpreted by the DB layer execution management module 482, which establishes a connection to the database and opens the database.

In Step 204 (S204), the DB layer execution management module 482 (FIG. 10) interprets the program module for database operation (the DB operation #1) that is provided by the library 488, and operates the database (the DBMS 302 and the database module 300 in FIG. 9) via the DB layer control module 464.

In Step 206 (S206), the DB layer execution management module 482 judges a returned value from the database to determine whether or not the processing executed in S204 is a success.

The program execution control module 46 proceeds to processing of S208 in the case where the processing is a success, and moves to processing of S114 in any other cases.

In Step 208 (S208), the UI/AP layer execution management module 480 (FIG. 10) starts second processing (the DB operation #2) for operating the database (the DBMS 302 and the database module 300 in FIG. 9), and activates processing of the database layer program.

The database layer program for the second processing is, similarly to the program for the first processing, provided by the library 488 as a program module that is made into components.

In Step 110 (S110), the DB layer execution management module 482 (FIG. 10) judges a returned value from the database to determine whether or not the processing executed in S204 is a success.

The program execution control module 46 proceeds to processing of S112 in the case where the processing is a success, and moves to the processing of S114 in any other cases.

In Step 112 (S112), the DB layer execution management module 482 (FIG. 10) commits what operation has been performed on the database (the DBMS 302 and the database module 300 in FIG. 9), and sends the processing results and a returned value to the UI/AP layer execution management module 480.

In Step 114 (S114), the DB layer execution management module 482 cancels an operation performed on the database, rolls back the operation, and sends the processing results and a returned value to the UI/AP layer execution management module 480.

In Step 116 (S116), the DB layer execution management module 482 cuts the connection with the database and closes the database via the data management module 484.

The UI/AP layer execution management module 480 controls the service providing module 304 via the UI layer control module 460 and the AP layer control module 462 in accordance with the processing results and the returned value that are entered by the DB layer execution management module 482, to make the service providing module 304 perform necessary processing such as displaying the processing results on the input/output device 126 (FIG. 8) of the client PC 102 (FIG. 7).

The memory area management module 486 frees the memory areas and the transaction management module 490 performs processing of ending the transaction.

In the processing of the program shown in FIG. 2 as an example, disconnection from the database and closing of the database are not carried out until every kind of database layer processing is finished irrespective of whether the individual database layer processing is a success or not.

The processing of the control program 44 shown in FIGS. 11-13 as an example differs from the processing of FIG. 2 in that the disconnection and closing are carried out at the first failure of database layer processing or when every kind of database layer processing is finished.

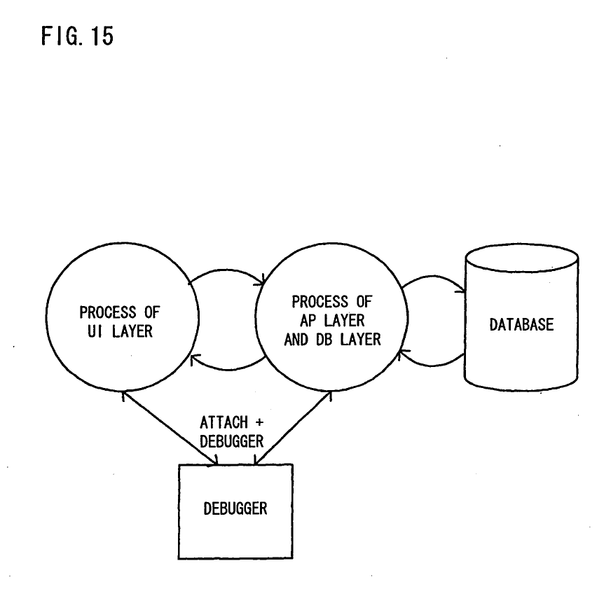

FIG. 15 is a diagram illustrating the ease of debugging of the control program 44 with the development/control program 40 (FIG. 10).

As shown in FIG. 15, when the development/control program 40 (FIG. 10) is used to develop and debug the control program 44, the process of the user interface layer and the process of the application layer and of the database layer are both executed under the control of the same program execution control module 46.

Therefore, with the development/control program 40, the user interface layer of the control program 44 can be debugged by the same debugger 422 that is used to debug the application layer and the database layer.

Since the use of the development/control program 40 eliminates the need to debug the user interface layer with a different debugger from the one used in debugging of the application layer and the database layer as shown in FIG. 6, it facilitates debugging of the control program 44 compared to the case shown in FIG. 6.

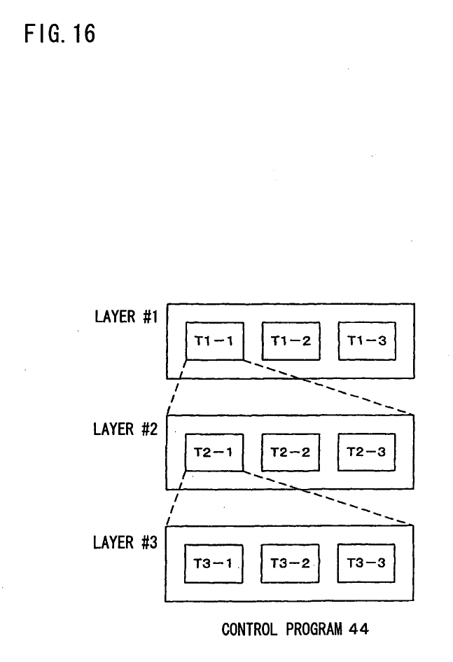

FIG. 16 is a program showing as an example the control program 44 that includes multiple transactions in each layer.

While the control program 44 shown in FIGS. 11-13 as an example has one transaction defined in one layer, in practice, multiple transactions (e.g., T1-1 to T1-3 in a layer #1) may be defined per layer of the control program 44 as shown in FIG. 16.

Also, in processing activated by one transaction (e.g., T1-1), more transactions (e.g., T2-1 to T2-3) may be defined.

The program execution control module 46 (FIG. 10) can perform the same execution management on the control program 44 shown in FIG. 16 as an example as the one performed on the control program 44 that is shown in FIGS. 11-13 as an example.

### INDUSTRIAL APPLICABILITY

The present invention is applicable to database operation.

1. A database operating device for operating a database through processing divided into multiple layers, the processing being one or both of activating processing, which activates processing of another layer, and activated processing, which is activated by the activating processing, one or more of the activated processing being database operation processing for operating the database, comprising:
a group defining means which defines a processing group including one or more of the activating processing; and
a processing control means which, in accordance with progress of the activating processing included in the processing group and a processing result of the database operation processing that is activated by the activating processing included in the processing group, controls at least what operation is performed on the database through the database operation processing; a storage area setting means which sets, for each of the processing groups, a storage area for the activating processing that is included in the processing group and the activated processing that is activated by the activating processing included in the processing group; and a data management means which manages data used for processing included in each of the processing groups in the storage areas that are set to the respective processing groups.

2. A database operating device according to claim 1,
wherein the layers are three or more separate layers, and
wherein the processing control means further controls, in accordance with the progress of the activating processing included in the processing group and the processing result of the activated processing that is activated by the activating processing included in the processing group but is not database operation processing, processing specifics (contents) of the activated processing that is not database operation processing.

3. A database operating device according to claim 1, further comprising a library means which includes one or more of the database operation processing,
wherein activating processing that activates the database operation processing activates the database operation processing included in the library means.

4. (canceled)

5. A database operating device according to claim 1,
wherein each one of the activated processing sends a returned value which shows the processing result to the activating processing that activates this activated processing,
wherein the layers include an interface layer, an application layer, and a database layer,
wherein the interface layer includes one or more of user interface processing which activates, as the activating processing, in response to external operation, the activated processing that is included in the application layer, and performs processing in accordance with the returned value sent from the activated processing that is activated by the user interface processing,
wherein the application layer includes one or more of application processing which, as the activating processing and the activated processing, is activated by the interface processing, activates one or more of the database operation processing included in the database layer, carries out a service that uses the database in accordance with the returned value sent from the activated database operation processing, and sends a result of the service as the returned value to the user interface processing, and
wherein the database layer includes one or more of the database operation processing which, as the database operation processing, is activated by the application processing, operates the database, and sends a result of the operation of the database as the returned value to the application processing.

6. A database operating device according to claim 5, wherein the processing control means controls execution of the database operation processing as follows:
when the application processing included in the processing group activates the database operation processing for the first time, the activated database operation processing is connected to the database; and
when the database operation processing that is activated last by the application processing included in the processing group ends, or when the database operation processing fails, the activated database operation processing is disconnected from the database.

7. A database operating device according to claim 5,
wherein the processing control means commits to the database a result of the database operation processing activated by the application processing included in the processing group in a case where the database operation processing that is activated last by the application processing included in the processing group is successful, and
wherein, in any other cases, the processing control means restores the database to a state before the database operation processing is first activated by the application processing included in the processing group.

8. A database operating device according to claim 5, wherein, when the database operation processing activated by the application processing included in the processing group fails, the processing control means restores the database to a state before the database operation processing is first activated by the application processing included in the processing group.

9. An information processing device for performing given information processing through processing divided into multiple layers, the processing being one or both of activating processing, which activates processing of another layer, and activated processing, which is activated by the activating processing, comprising:
a group defining means which defines a processing group including one or more of the activating processing; and
a processing specifics control means which, in accordance with progress of the activating processing included in the processing group and a processing result of the activated processing that is activated by the activating processing included in the processing group, controls the specifics of the activated processing; a storage area setting means which sets, for each of the processing groups, a storage area for the activating processing that is included in the processing group and the activated processing that is activated by the activating processing included in the processing group; and a data management means which manages data used for processing included in each of the processing groups in the storage areas that are set to the respective processing groups.

10. A database operating method of operating a database through processing divided into multiple layers, the processing being one or both of activating processing, which activates processing of another layer, and activated processing, which is activated by the activating processing, one or more of the activated processing operating the database, comprising:
a defining step which defines a processing group including one or more of the activating processing; and
a processing control step which, in accordance with progress of the activating processing included in the processing group and a processing result of database operation processing that is activated by the activating processing included in the processing group, controls at least what operation is performed on the database through the database operation processing; a storage area setting step which sets for each of the processing groups, a storage area for the activating processing that is included in the processing group and the activated processing that is activated by the activating processing included in the processing group, and a data management step which manages data used for processing included in each of the processing groups in the storage areas that are set to the respective processing groups.

11. A database operating method according to claim 10,
wherein the layers are three or more separate layers, and
wherein the processing control step further controls, in accordance with the progress of the activating processing included in the processing group and the processing result of the activated processing that is activated by the activating processing included in the processing group but is not database operation processing, processing specifics (contents) of the activated processing that is not database operation processing.

12. An information processing method for performing given information processing through processing divided into multiple layers, the processing being one or both of activating processing, which activates processing of another layer, and activated processing, which is activated by the activating processing, comprising:
a group defining step of defining a processing group which includes one or more of the activating processing; and
a processing specifics control step of controlling, in accordance with progress of the activating processing included in the processing group and a processing result of the activated processing that is activated by the activating processing included in the processing group, specifics of the activated processing; a storage area setting step of setting, for each of the processing groups, a storage area for the activating processing that is included in the processing group and the activated processing that is activated by the activating processing included in the processing group; and a data management step of managing data used for processing included in each of the processing groups in the storage areas that are set to the respective processing groups.

13. A program for a database operating device for operating a database through processing divided into multiple layers, the processing being one or both of activating processing, which activates processing of another layer, and activated processing, which is activated by the activating processing, one or more of the activated processing being database operation processing for operating the database, where the program causes a computer to execute:
a group defining step which defines a processing group including one or more of the activating processing; and
a processing control step which, in accordance with progress of the activating processing included in the processing group and a processing result of database operation processing that is activated by the activating processing included in the processing group, controls at least what operation is performed on the database through the database operation processing; a storage area setting step which sets, for each of the processing groups, a storage area for the activating processing that is included in the processing group and the activated processing that is activated by the activating processing included in the processing group; and a data management step which manages data used for processing included in each of the processing groups in the storage areas that are set to the respective processing groups.

14. A program according to claim 13,
wherein the layers are three or more separate layers, and
wherein the processing control step further controls, in accordance with the progress of the activating processing included in the processing group and the processing result of the activated processing that is activated by the activating processing included in the processing group but is not database operation processing, processing specifics (contents) of the activated processing that is not database operation processing.

15. A program according to claim 13, further comprising a library means which includes one or more of the database operation processing,
wherein activating processing that activates the database operation processing activates the database operation processing included in the library means.

16. (canceled)

17. A program according to claim 13,
wherein each one of the activated processing sends a returned value which shows the processing result to the activating processing that activates this activated processing,
wherein the layers include an interface layer, an application layer, and a database layer,
wherein the interface layer includes one or more of user interface processing which activates, as the activating processing, in response to external operation, the activated processing that is included in the application layer, and performs processing in accordance with the returned value sent from the activated processing that is activated by the user interface processing,
wherein the application layer includes one or more of application processing which, as the activating processing and the activated processing, is activated by the interface processing, activates one or more of the database operation processing included in the database layer, carries out a service that uses the database in accordance with the returned value sent from the activated database operation processing, and sends a result of the service as the returned value to the user interface processing, and
wherein the database layer includes one or more of the database operation processing which, as the database operation processing, is activated by the application processing, operates the database, and sends a result of the operation of the database as the returned value to the application processing.

18. A program according to claim 17, wherein the processing control step controls execution of the database operation processing as follows:
when the application processing included in the processing group activates the database operation processing for the first time, the activated database operation processing is connected to the database; and
when the database operation processing that is activated last by the application processing included in the processing group ends, or when the database operation processing fails, the activated database operation processing is disconnected from the database.

19. A program according to claim 17,
wherein the processing control step commits to the database a result of the database operation processing activated by the application processing included in the processing group in a case where the database operation processing that is activated last by the application processing included in the processing group is successful, and
wherein, in any other cases, the processing control step restores the database to a state before the database operation processing is first activated by the application processing included in the processing group.

20. A program according to claim 17, wherein, when the database operation processing activated by the application processing included in the processing group fails, the processing control step restores the database to a state before the database operation processing is first activated by the application processing included in the processing group.

21. A program of an information processing device for performing given information processing through processing divided into multiple layers, the processing being one or both of activating processing, which activates processing of another layer, and activated processing, which is activated by the activating processing, wherein the program causes a computer to execute:
a group defining step of defining a processing group which includes one or more of the activating processing; and
a processing specifics control step of controlling, in accordance with progress of the activating processing included in the processing group and a processing result of the activated processing that is activated by the activating processing included in the processing group, specifics of the activated processing; a storage area setting step of setting, for each of the processing groups, a storage area for the activating processing that is included in the processing group and the activated processing that is activated by the activating processing included in the processing group; and a data management step of managing data used for processing included in each of the processing groups in the storage areas that are set to the respective processing groups.

22. A database operating device for operating a database through processing divided into multiple layers, the processing being one or both of activating processing, which activates processing of another layer, and activated processing, which is activated by the activating processing, one or more of the activated processing operating the database, comprising:
a group defining means which defines, for each of the layers, a processing group including one or more of the activating processing; and
a processing control means which, in accordance with progress of the activating processing included in the processing group and a processing result of database operation processing that is activated by the activating processing included in the processing group, controls at least what operation is performed on the database through the database operation processing.

23. A database operating device according to claim 22,
wherein the layers are three or more separate layers, and
wherein the processing control means further controls, in accordance with the progress of the activating processing included in the processing group and the processing result of the activated processing that is activated by the activating processing included in the processing group but is not database operation processing, processing specifics (contents) of the activated processing that is not database operation processing.

24. A database operating device according to claim 22, further comprising a library means which includes one or more of the database operation processing,
wherein activating processing that activates the database operation processing activates the database operation processing included in the library means.

25. A program for a database operating device for operating a database through processing divided into multiple layers, the processing being one or both of activating processing, which activates processing of another layer, and activated processing, which is activated by the activating processing, one or more of the activated processing being database operation processing for operating the database, where the program causes a computer to execute:
a group defining step which defines, for each of the layers, a processing group including one or more of the activating processing; and
a processing control step which, in accordance with progress of the activating processing included in the processing group and a processing result of the database operation processing that is activated by the activating processing included in the processing group, controls at least what operation is performed on the database through the database operation processing.

26. A program according to claim 25,
wherein the layers are three or more separate layers, and
wherein the processing control step further controls, in accordance with the progress of the activating processing included in the processing group and the processing result of the activated processing that is activated by the activating processing included in the processing group but is not database operation processing, processing specifics (contents) of the activated processing that is not database operation processing.

27. A program according to claim 25, further comprising a library which includes one or more of the database operation processing,
wherein activating processing that activates the database operation processing activates the database operation processing included in the library.
